(19) United States
(12) Patent Application Publication
(10) Pub. No.: US 2023/0183618 A1
(43) Pub. Date: Jun. 15, 2023

(54) AGENT FOR LIQUEFYING CRUDE OIL AND/OR FOR REMOVING OIL RESIDUES

(71) Applicants: Alwin Ehrl, Langenbruck (DE); Rainer Ott, Ingolstadt (DE)

(72) Inventors: Alwin Ehrl, Langenbruck (DE); Rainer Ott, Ingolstadt (DE)

(21) Appl. No.: 17/923,622

(22) PCT Filed: May 7, 2020
(86) PCT No.: PCT/EP2020/062785

§ 371 Date: Nov. 7, 2022

(51) Int. Cl. C11D 7/26; C11D 11/00

(52) U.S. Cl. CPC C11D 7/266; C11D 7/261; C11D 7/264; C11D 11/0041

(57) ABSTRACT

The invention relates to a composition comprising a fatty acid-methyl ester component and an alcohol component, the composition being liquid at normal pressure at 20° C. and being immiscible with water. The invention further relates to a mixture containing crude oil, oil sludge and/or oil residues and the aforementioned composition. The invention also relates to a method for reducing the viscosity of crude oil, oil sludge and/or oil residues. The invention finally relates to a method for cleaning a surface from crude oil, oil sludge and/or oil residues.

### TECHNICAL FIELD

The invention relates to a composition comprising a fatty acid methyl ester component and an alcohol component. Furthermore, the invention relates to a mixture comprising crude oil, oil sludge and/or oil residues and the above composition. Furthermore, the invention relates to a method for reducing the viscosity of crude oil, oil sludge and/or oil residues. Furthermore, the invention relates to a method for cleaning a surface from crude oil, oil sludge and/or oil residues.

### BACKGROUND OF THE INVENTION

A hitherto unsolved problem in the crude oil industry is the environmentally friendly removal of oil residues and oil sludge, e.g. from storage tanks. Over time highly viscous components accumulate at the bottom of these storage tanks, which generally have a capacity of several thousand cubic meters.

Tanks for flammable liquids, in particular oil tanks such as large oil tanks, must be cleaned for reasons of inspection as well as in case of heavy contamination by sediments after several years (3 to 8 years) of operation. When these tanks are emptied, there regularly remains a residual sump of oil sludge and oil residues.

Currently, the most common method for cleaning these storage tanks is the mechanical and chemical removal of highly viscous or solid components before the tanks are refilled with oil. These residues must be disposed of, comparable to tar, which results in extensive sales loss and environmental impact.

Furthermore, there are unsolved problems in the extraction of crude oil. For example, crude oil is pumped from reservoirs for extraction, whereby the pumpability of the crude oil also depends on the viscosity of the crude oil. At the beginning of the production phase, in so-called primary production, a pressure in the reservoir is high enough without additional measures to extract the crude oil, either by squeezing with the help of the naturally existing reservoir pressure or by pumping. If the reservoir pressure drops in the course of production, the pressure can be increased by artificial measures such as injecting water into the reservoir to continue producing crude oil, which is referred to as secondary recovery. However, the increasingly viscous and dense oil, hampers the further constant oil production. Tertiary recovery summarizes techniques of oil production that enable an oil production achievable with primary and secondary methods. One of the main objectives of tertiary recovery is to push the oil to the surface by injecting chemicals at high pressure. In addition to the purely mechanical effect of the chemicals, it is further desirable, that the chemicals reduce the viscosity of the crude oil in order to improve the pumping characteristics.

### DESCRIPTION OF THE INVENTION

Accordingly, it is an object of the present invention to provide means and ways for reducing the viscosity of crude oil and thus to simplify the cleaning of oil tanks and surfaces and the production of crude oil. In particular, it is intended to provide means which do not adversely affect the further processing of the crude oil extracted. Likewise, the cleaning of oil tanks and surfaces is to be made more careful, cheaper, faster, more efficient and/or more environmentally compatible.

These objects are achieved by the subject matter of the independent claims. Preferred further developments of the invention are described in the subclaims.

According to the invention, there is thus provided a composition comprising a fatty acid methyl ester component and an alcohol component, wherein the composition is liquid at normal pressure at 20° C. and a proportion of the fatty acid methyl ester component is ≥ 65 to ≤ 95 % by weight, preferably ≥ 70 to ≤ 90 % by weight, based on the total weight of the composition.

In the sense of the invention, normal pressure is understood to mean the pressure at 1 bar. Further preferably, the composition is also liquid at 1.01325 bar. Preferably the composition is not miscible with water, which means that the composition is not soluble in water and thus does not form a homogeneous mixture when mixed with water. Preferably, when mixed with water, at least two separate phases are formed.

Thus, a composition for reducing the viscosity of crude oil, oil sludge and/or oil residues is provided. The composition liquefies solid oil components such as oil sludge and/or oil residues and thus enables an easy removal of oil sludge and/or oil residues. Furthermore, the composition reduces the viscosity of already liquid crude oil and thus makes highly viscous crude oil more flowable.

The composition according to the invention enables a reduction of the viscosity of crude oil and a liquefaction of solid components such as oil sludge and oil residues. Thus the composition enables easy tank cleaning. The composition also enables companies to carry out scheduled tank cleaning not only in time, but faster than with conventional mechanical means alone. In addition, the composition has a positive effect on the recyclability of the oil sludge and/or oil residues, because a large part of the oil sludge and/or oil residues can be refined. Thus, the environment is protected, since the oil sludge and/or oil residues do not have to undergo any further special treatment or disposal. Furthermore, the composition according to the invention can be used in crude oil production, particularly in tertiary recovery, in order to reduce the viscosity of the crude oil and to improve the production.

The composition preferably reduces the surface tension of the crude oil, the oil sludge and/or oil residues, and preferably does not alter the chemical structure of the molecules of the crude oil, the oil sludge and/or the oil residues. In other words, the organic hydrocarbon atoms of the crude oil, the oil sludge and/or the oil residues are preferably not altered as is the case in catalytic cracking.

In accordance with a preferred further development of the invention, a proportion of the alcohol component is ≥ 5 to ≤ 35 % by weight, preferably ≥ 7 to ≤ 28 % by weight, based on the total weight of the composition. It has been shown that a composition with these proportions by weight is particularly efficient in reducing the viscosity of the crude oil, or liquifies oil residues and/or oil sludge.

With regard to the fatty acid methyl ester component, according to a preferred further development of the invention, it is provided that the fatty acid methyl ester component exclusively comprises methyl esters of fatty acids having a length between 10 and 24 carbon atoms, preferably between 10 and 18 carbon atoms in linear arrangement. In other words, the fatty acid methyl ester component preferably comprises fatty acid methyl esters of unbranched chained fatty acids comprising 10 to 18 carbon atoms.

In this context, according to another preferred further development, it is provided that the fatty acid methyl ester component comprises one or more fatty acid methyl esters selected from
a) hexadecanoic acid methyl ester,
b) octadecanoic acid methyl ester,
c) 9-octadecenoic acid methyl ester,
d) 9,12-octadecadienoic acid methyl ester, and
e) 9,12,15-octadecadienoic acid methyl ester.

Other fatty acid methyl esters are possible in the composition.

It has been shown that the above-mentioned fatty acid methyl esters are particularly well suited to reduce the viscosity of the crude oil. Even more preferably, the composition according to the invention comprises all fatty acid methyl esters a) - e) in combination.

In principle, it is possible to produce the composition, and in particular the fatty acid methyl ester component from synthetic light oil and/or crude oil. Preferably, it is provided that the composition is produced or can be produced from soybean oil, rapeseed oil, palm oil, tallow or used frying fat. This has the advantage that the production of the composition is very resource-saving.

In other words, the composition and in particular the fatty acid methyl ester component is preferably obtained from a biological natural product. As sustainable raw materials soybean oil, rapeseed oil or even animal fats or used frying fat come into question.

With respect to the alcohol component, in accordance with a preferred further development of the invention it is provided that the alcohol component comprises one or more monovalent C₂ to C₄ alcohols. A monovalent alcohol is an alcohol that has exactly one -OH group. Preferably, the monovalent alcohol does not have any other functional groups. Further preferred, the alcohol component is selected from the group comprising ethanol, n-propanol, iso-propanol, n-butanol, tert-butanol as well as mixtures thereof. Particularly preferred are ethanol, iso-propanol, n-butanol, and tert-butanol.

According to another preferred further development of the invention, the composition comprises at least one liquefier component selected from
a) lauric acid, and
b) ethanolamine.

In particular in the case of highly viscous crude oil, very persistent oil pressures and in the tertiary recovery it has been shown that the liquefier component can reduce the viscosity of the crude oil very effectively, or that the residues can be liquefied very quickly. Lauric acid, also known as dodecanoic acid, is a saturated fatty acid, derived from the alkane n-dodecane. Ethanolamine also known as monoethanolamine, 2-aminoethan-1-ol, or MEA, is an organic chemical compound belonging to the group of substances of the amino alcohols.

Preferably, the composition comprises the liquefier component in a proportion of ≤ 4%, preferably ≤ 2% by weight, based on the total weight of the composition. These proportions have been found to be particularly effective in reducing the viscosity or for liquefying the crude oil.

According to a preferred further development of the invention, the composition further comprises camphor. Camphor is preferably present in a proportion of 0.0015% by weight, based on the total weight of the composition.

Particularly preferably, the composition comprises 70 - 90% by weight of the fatty acid methyl ester component, 7 - 27.9985% by weight of the alcohol component and 2% by weight of the liquefier component, respectively based on the total weight of the composition.

Further preferably, the composition comprises 70 - 90% by weight of the fatty acid methyl ester component, 7 - 27.9985% by weight of the alcohol component, 2% by weight of the liquefier component and 0.0015% by weight camphor, respectively based on the total weight of the composition.

Preferably, the composition is not miscible with water. In this context, according to a preferred further development of the invention, it is provided that the composition is miscible with crude oil in any ratio. In other words, a homogeneous mixture is obtained when the composition is mixed with crude oil, so that no separate phases are present. Preferably, this mixing behavior is independent of the proportions of crude oil and of the composition.

An advantage of the composition is that the composition can remain in the crude oil. It does not adversely affect the oil properties and can be refined together with the crude oil without any problems.

In this context, according to a another preferred further development of the invention, it is provided, that the composition does not comprise surfactants. Here, surfactants are understood to mean anionic surfactants, cationic surfactants and non-ionic surfactants. Many compositions known in the state of the art for the removal of oil residues include surfactants to enable the oil residues to be dispersed in water. However, the surfactants may have a detrimental effect on the crude oil, so that the crude oil can no longer be refined as usual. Moreover, the surfactants have to be taken into account in disposing the oil residues. Accordingly, dispensing with surfactants in the composition has the advantage that the properties of the crude oil are not affected.

Preferably, it is provided that the composition has a boiling range with a lower boiling point of between 300 and 600° C. at normal pressure. Further, it is preferably provided that the composition is non-oxidizing and/or reducing. It is also preferably provided that the composition has a density of 875 - 900 g/l and/or a self-ignition temperature is preferably between 120 and 180° C. Further preferably, the kinematic viscosity of the composition is between 3.5 and 5 cSt at 40° C., determined according to EN ISO 3104.

The compositions according to the invention are thus particularly suitable for cleaning of containers containing crude oil, oil residues and/or oil sludge, in particular paraffinic oils, heavy oil or bitumen. In particular, the composition is suitable for the cleaning of oil tanks, preferably storage tanks for crude oil.

In particular, the composition is suitable for reducing the viscosity of highly viscous crude oil and for the liquefaction of solid oil residues, in particular oil sludge, heavy oil or bitumen.

Furthermore, the invention relates to a mixture comprising crude oil, oil sludge and/or oil residues and the above composition. Preferably, the mixture of the composition and the crude oil, the oil sludge and/or the oil residues is a homogeneous mixture. Compared to the crude oil, the oil sludge and/or the oil residues the mixture has a reduced viscosity and thus an improved pumpability.

Preferably, crude oil is understood to mean oil as it occurs naturally in the earth’s crust, i.e. crude oil that has not been further processed. In the sense of the invention, crude oil thus comprises a mixture of substances consisting mainly of hydrocarbons, which has been obtained by conversion processes of organic substances. Oil sludge and oil residues in the sense of the invention are understood to mean very highly viscous and solid constituents which settle during storage of the crude oil. Examples of oil residues are bitumen, oil sand and heavy oil.

Further preferably, the composition is present in the mixture in a proportion of 2 - 10% by weight, based on the weight of crude oil, oil sludge and/or oil residues. It has been shown that this mixing ratio has a particularly positive influence on the pumpability of the mixture.

Further preferably, the alcohol component of the composition is adjusted to the nature of the crude oil, of the oil sludge and/or the oil residues and/or a temperature. In the case of high viscosity crude oil, the alcohol component of the composition is preferably iso-propanol. For oil sands, the alcohol component of the composition is preferably ethanol. If the mixture is used in situations where an outside temperature or the temperature of the mixture is above 25° C., the alcohol component of the composition is preferably n-butanol and/or tert-butanol.

Further preferably, the liquefier component of the composition is adjusted to the nature of the crude oil, the oil sludge and/or the oil residues. In the case of highly viscous crude oil and/or oil sand, the liquefier component of the composition is preferably lauric acid. In the case of oil slag, and particularly in the case of high viscosity oil slag, the liquefier component of the composition is preferably ethanolamine.

The mixture has the advantage of reducing deposits in pipes used for transportation of the mixture. Furthermore, especially at flange transitions and pipe sleeves, less heating energy can be used to prevent the pipes from freezing, because the mixture remains liquid for a longer period of time. By lowering the viscosity compared to crude oil, the flow rate increases and the maintenance intervals for pipes and drill pipe are extended.

Other advantages of the composition and of the mixture can be summarized as follows:
Approximately 90% to 100% of the oil residues can be recycled and refined.
Cost-intensive disposal of oil residues is no longer necessary.
Cost-intensive treatment of the residues can be reduced to less than 10% of the oil residues.
The time saving saves a considerable amount of money.
As approx. 90% of the oil residues can be recycled, environmental pollution is reduced to a minimum.
The slow mechanical removal of highly viscous or solid components can be reduced by 90% by use of the invention, which saves nearly 65% of the usual time.

Furthermore, the invention relates to a method for reducing the viscosity of crude oil, oil sludge and/or oil residues comprising the steps of:
Providing crude oil, oil sludge and/or oil residues,
providing a composition as described above,
bringing the composition into contact with the crude oil, the oil sludge and/or the oil residues.

The method allows in a simple and efficient way to reduce the viscosity of crude oil and to liquefy very high viscous and solid components of the crude oil. Reducing the viscosity is also understood to mean the liquefaction of solid components.

According to a preferred further development, the composition, when brought into contact, has a temperature between -10 and 280° C. This accelerates the reduction of viscosity, so that the method is particularly efficient.

The composition can be used at different temperatures to reduce the viscosity. Temperature ranges from -10° C. to 280° C. are possible. The method can also be used at outside temperatures in the minus range. In practice, this is of particular interest for cleaning heating loops in refineries. The composition preferentially binds residual water and oxygen. Further preferred the composition, when brought into contact, has a temperature between 20 and 60° C. This is particularly interesting for liquefying oil residues in oil tanks or on surfaces.

According to another preferred further development, the composition is brought into contact with the crude oil, the oil sludge and/or the oil residues in a proportion of 2 - 10% by weight, based on the weight of crude oil, oil sludge and/or oil residues provided. Thus, in order to reduce the viscosity of the crude oil and/or to liquefy solid components, only small amounts of the composition are required.

According to another preferred further development of the invention, the method comprises the step of refining a mixture which is formed by the step of bringing into contact the composition with the crude oil, the oil sludge and/or the oil residues and which comprises the crude oil, the oil sludge and/or the oil residues and the composition. The method has the advantage that the mixture can be further processed with the usual processing steps for crude oil such as refining, and the composition does not adversely affect the further processing.

Furthermore, the invention relates to a method for cleaning a surface from crude oil, oil sludge and/or oil residues, comprising the steps of:
a) carrying out the above method for reducing the viscosity of crude oil, oil sludge and/or oil residues at the surface,
b) causing the composition to act on the crude oil, oil sludge and/or oil residue present on the surface, so that a liquid product is formed,
c) removing the liquid product from the surface, and
d) optionally cleaning the surface with water and/or reapplying the composition onto the surface.

The method can be used to clean surfaces of tools, ring wrenches, open-jaw wrenches, engine compartments, fuel dispensers, floors, walls, oil pans, hulls of ships and the like.

According to a preferred further development, the surface is an inner surface of an oil tank, wherein step a) comprises introducing the composition into the oil tank, step c) comprises pumping the liquid product out of the oil tank, and step d) comprises reapplying the composition onto the inner surface of the oil tank. The reapplication of the composition has the advantage of reducing future deposits at the inner surface of the oil tank. In this way, the oil tank needs to be cleaned less often.

### BRIEF DESCRIPTION OF THE DRAWINGS

In the following, the invention is described further in detail based on a preferred exemplary embodiment of the invention with reference to the drawings.

In the drawings:

FIG. 1 shows viscosity measurements of mixtures of crude oil and a composition in different proportions, according to a preferred exemplary embodiment of the invention;

FIG. 2 shows a viscosity measurement of a mixture of crude oil and a composition according to a further preferred exemplary embodiment of the invention, and for comparison a viscosity measurement of the crude oil without composition; and

FIG. 3 shows a surface before, during and after cleaning with a composition according to a further preferred exemplary embodiment of the invention;

### DETAILED DESCRIPTION OF THE EMBODIMENTS

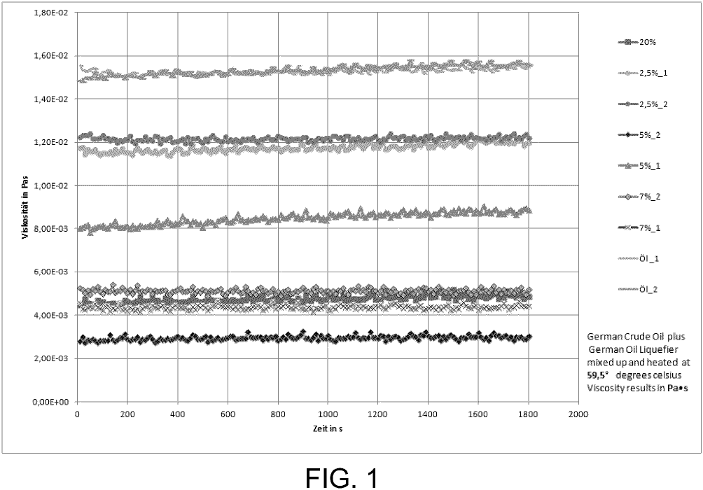

FIG. 1 shows the decrease in viscosity of German crude oil by addition of the composition according to a preferred exemplary embodiment of the invention. The composition of the first exemplary embodiment is hereinafter referred to as A1111. A1111 has the following composition:

| Components | Weight proportion based on total weight of the composition |
|---|---|
| Fatty acid methyl ester component Mixture of a) hexadecanoic acid methyl ester, b) octadecanoic acid methyl ester, c) 9-octadecenoic acid methyl ester, d) 9,12-octadecadienoic acid methyl ester and e) 9,12,15-octadecadienoic acid methyl ester | 90% |

| | |
|---|---|
| Alcohol component: iso-propanol | 9.9985% |
| Camphor | 0.0015% |

Several crude oil samples of German crude oil were mixed with different amounts of the composition A1111. The mixtures were each heated to 59.5° C. and stirred at 59.5° C. for 5 minutes. Subsequently, the dynamic viscosity was determined according to EN ISO 3219. The shear rate was respectively 200 s⁻¹ and the measuring time was 30 minutes at a measuring temperature of 59.5° C. FIG. 1 shows the viscosity obtained for the mixtures of German crude oil, with the composition A1111 at 59.5° C. with different weight proportions of the composition in the mixture, based on the weight of the crude oil sample. The highest viscosity is shown for the crude oil samples “ÖI_1” and “ÖI_2”, to which no A1111 was added. Significantly lower viscosities were found with proportions of 5 to 7% of A1111. A mixture of crude oil and A1111 with a proportion 20% by weight of A1111, based on the weight of the crude oil, was taken as a reference. The measurements show that a mixture of crude oil and A1111 with more than 7% addition of A1111, based on the weight of the crude oil, does not significantly further reduce the viscosity.

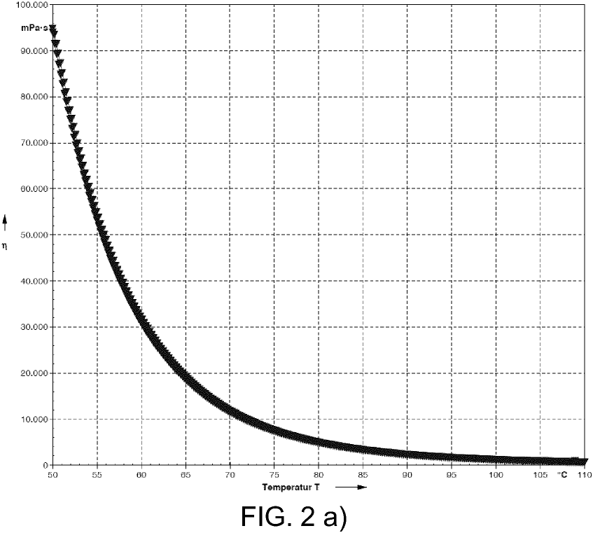

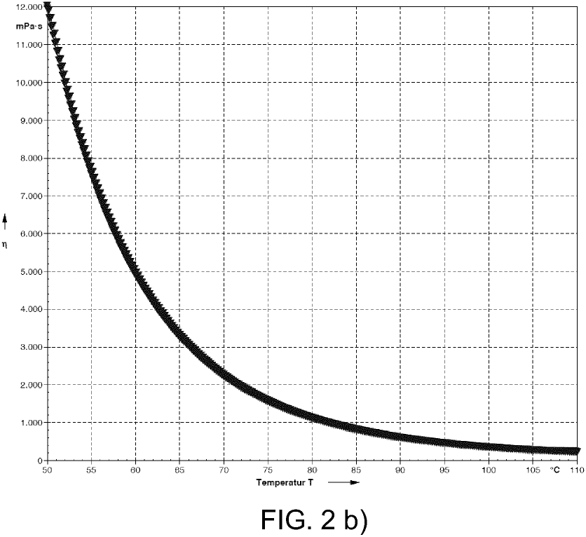

FIG. 2a) and 2b) show viscosity measurements of crude oil once without addition of a composition (FIG. 2a) and once with the addition of the composition according to a further preferred exemplary embodiment of the invention. The composition of the second preferred exemplary embodiment will be referred to in the following as LIQUI. LIQUI has the following composition:

| Components | Weight proportion based on total weight of the composition |
|---|---|
| Fatty acid methyl ester component Mixture of a) hexadecanoic acid methyl ester, b) octadecanoic acid methyl ester, c) 9-octadecenoic acid methyl ester, d) 9,12-octadecadienoic acid methyl ester and e) 9,12,15-octadecadienoic acid methyl ester | 70% |
| Alcohol component: Mixture of ethanol and iso-propanol | 27.9985% |
| Camphor | 0.0015% |
| Liquefier component: Lauric acid | 2% |

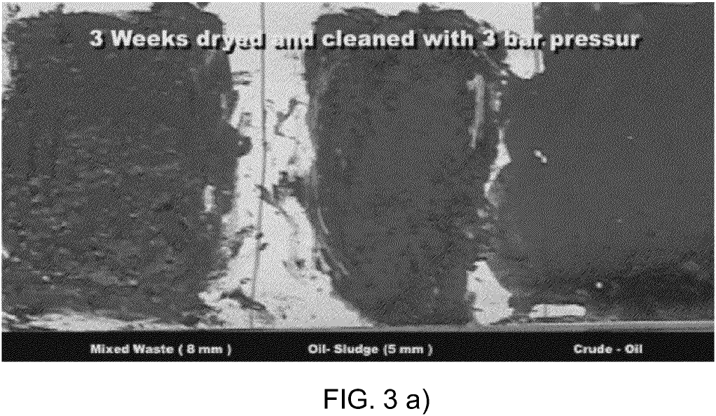

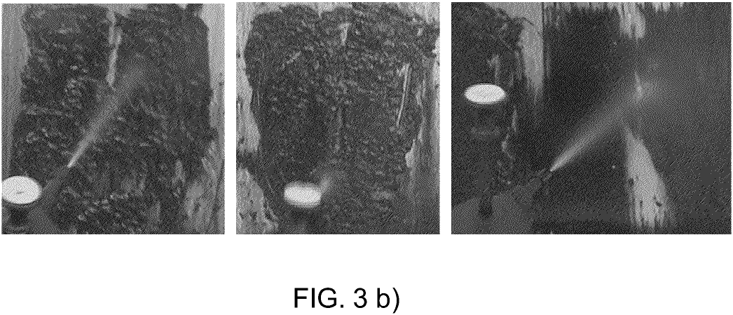

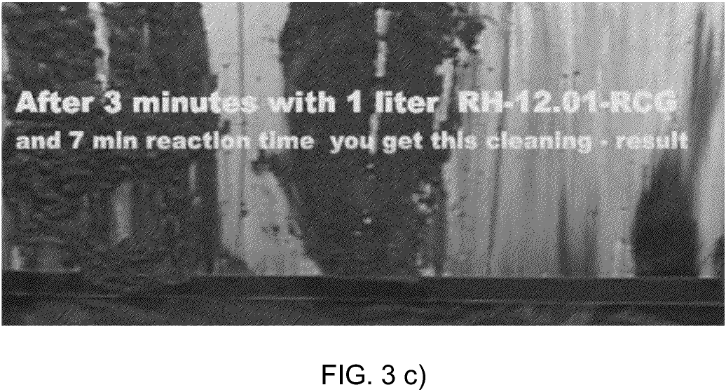

The dynamic viscosity of the crude oil sample was determined in accordance with EN ISO 3219, wherein the results are shown in FIG. 2a). LIQUI was also added to the crude oil sample in a proportion of 7.5% by weight, based on the mixture of crude oil and LIQUI, and the dynamic viscosity was determined in accordance with the above-mentioned rule (FIG. 2b). The dynamic viscosity of the mixture of crude oil and LIQUI is significantly lower. For example, the dynamic viscosity at 60° C. for the crude oil sample without LIQUI is 31.1 mPas and for the mixture of crude oil and LIQUI 4.9 mPas. FIG. 3 shows a cleaning of three different oil contaminations on steel sheet with the use of a composition according to a third preferred exemplary embodiment of the invention.

The composition of the third preferred exemplary embodiment is hereinafter referred to as RH-12.01-RCB. RH-12.01-RCB has the following composition:

| | |
|---|---|
| Components | Weight proportion based on total weight of the composition |
| Fatty acid methyl ester component Mixture of a) hexadecanoic acid methyl ester, b) octadecanoic acid methyl ester, c) 9-octadecenoic acid methyl ester, d) 9,12-octadecadienoic acid methyl ester and e) 9,12,15-octadecadienoic acid methyl ester | 70% |
| Alcohol component: Mixture of ethanol and iso-propanol | 27.9985% |
| Camphor | 0.0015% |
| Liquefier component: | 2% |
| Ethanolamine | |

FIG. 3 shows the images before cleaning (FIG. 3 a) and after cleaning (FIG. 3 c). The almost quantitative removal of the oil contamination can be seen in all three cases. The amount of non-removable residues is only between 3% and 8% of the total oil contamination, depending on the consistency of the oil contamination.

The oil contaminations in FIG. 3 are the following oil contaminations:
German oil slag from a large refinery mixed with Indian oil sludge (I),
highly paraffinic oil sludge from India (II), and
German crude oil from Wietze (III).

All oil contaminations were applied to a large steel sheet with a 4 cm high rim and dried lying down in the sun for 3 weeks. Cleaning was then carried out on the upright standing sheet.

FIG. 3a shows from left to right the “Mixed Waste” oil slag 8 mm thick (I), then the “Sludge” oil sludge 5 mm thick (II) and on the right the dried crude oil about 2.5 mm thick (III). Using a scant liter of RH-12.01-RCB at 2.8 bar pressure in 3 minutes, the sludge and slag layer was broken up and the oil surface was cleaned. An exposure time of 7 minutes was left after spraying. FIG. 3 c shows the result of the treatment.

Factors such as quantity and exposure time are not as important for surface cleaning as they are for oil liquefaction in oil tanks, ship tanks and freight car tanks. Here hard sludge sediments can be tackled with exposure times or high nozzle pressure. Although the composition according to the preferred exemplary embodiment is able to withstand a high bar pressure, in reality far less pressure is required than with water, since the composition does not decisively clean by the pressure. Tank walls of older date are spared, since cleaning can also be carried out under 90 bar. Usually the lowest setting pressures are between 90 and 180 bar.

Other areas of application are as follows:

Wherever chemicals or water were previously used, the composition of the invention can be used for cleaning. In particular, this relates to tank flushing, railroad tanks, ship tanks, which require crude oil cleaning.

In surface cleaning, the following applications are conceivable: cleaning of tools, such as ring wrenches or open-jaw wrenches, workshop cleaning of dirty floors, tile walls, hand wash basins, work benches, soot soiled surfaces and buckets, oil pans, plastic containers or motorcycle chains. The cleaning of engines or the engine compartment (outside) is possible. If necessary, it is important to rinse the surfaces with water or steam cleaner.

Surfaces contaminated with gasoline (e.g. tank columns) can be cleaned well. It is preferable to rinse with water after cleaning. In the case of gasoline spills or oil spills, it is advisable to first add a little amount of the composition, allow to act briefly and then sprinkle with absorbent material. An inexpensive good solution is e.g. sawdust.

After cleaning oily palms, it is advisable to rinse well with water and to apply hand cream.

Copper and brass parts are preferably rinsed with water after application of the composition.

The composition can be used without and with high-pressure cleaner, without further chemicals or water in order to clean tools and inner ship hulls. It was found that not only the ship walls became clean, but also the up to 2 m layer (deposited, hardened oil sediment) was liquefied and became pumpable again.

In the following a method for cleaning a surface from crude oil, oil sludge and/or oil residues according to a preferred embodiment is described with reference to tank cleaning.

The composition according to a preferred exemplary embodiment of the invention is used directly as a cleaning agent in the storage tanks by means of the high-pressure spraying systems already permanently installed at the tank or with industrial high-pressure cleaners. It already starts to develop its liquefying properties when sprayed onto the walls. It is circulated with the highly viscous oil in a circulation process and sprayed onto the surfaces until the walls of the tanks have been cleaned. Subsequently the composition with the liquefied oil sludge is pumped out of the tank after several cleaning processes. Once the walls of the tank have been cleaned, the pumping process can be initiated by means of a suction float nozzle pump as soon as the liquefying effect with respect to the amount of sludge has developed. The mixture is pumped into and out of the tank via the recirculation process. This in turn means that the added composition has transformed the sludge into a pumpable product. This circulation continues until all sludge layers have been liquefied.

The use of agitators can help speed up the liquefaction process. Especially after cleaning the tank walls and prior to cleaning the bottom, depending on the tank type, agitators can be installed. The use of these devices significantly accelerates the process. After the product has been liquefied, the entire pumpable liquid can be returned to the refinery for refining. Only the substances that cannot be pumped through pipelines must be disposed of. This is the basis for the economic value of this process.

A particularly preferred composition of the present invention has the following physical and chemical properties.

| | |
|---|---|
| Physical state at 20° C. | liquid |
| Colour | colorless to yellow |
| Odor | characteristic |
| pH value | 5-9 |
| Boiling point range | 302.5° C. - 570° C. (ASTM 7169) |
| Melting range | -34 - -25° C. |
| Flash point | 17 - 37° C. (ISO 13736:2008) |
| Auto-ignition temperature | 255-330° C. (DIN 51794) |
| Vapor pressure, 20° C. | 2 - 6 hPa (DIN EN 16016-1) |
| Relative density at 20° C. | 0.860 to 0.895 g/ml (DIN EN ISO 12185) |
| Water solubility (g/l) | insoluble |
| Kinematic viscosity at 40° C. | 3.50 to 5.00 mm²/s |
| Dynamic viscosity at 20° C. | 3.00 to 4.00 mPas |
| Mixture of | |
| hexadecanoic acid methyl ester | |
| octadecanoic acid methyl ester, | |
| 9-octadecenoic acid methyl ester, | |
| 9,12-octadecadienoic acid methyl ester, | |
| 9,12,15-octadecadienoic acid methyl ester, | |
| ethanol, | |
| n-propanol | |
| iso-propanol, | |
| tert-butanol, | |
| lauric acid, | |
| ethanolamine | |

The embodiments described are merely examples which can be modified and/or supplemented in a variety of ways within the scope of the claims. Each feature described for a particular exemplary embodiment may be used independently or in combination with other features in any other exemplary embodiment. Any feature that has been described for an exemplary embodiment of a particular category can also be used in a corresponding manner in an exemplary embodiment of another category.

1. Composition comprising a fatty acid methyl ester component, an alcohol component, and lauric acid,
wherein the composition is liquid at normal pressure at 20° C.,
a proportion of the fatty acid methyl ester component is ≥ 65 to 95% by weight, preferably ≥ 70 to ≤ 90% by weight, based on the total weight of the composition,
a proportion of the alcohol components is ≥ 5 to ≤ 35% by weight based on the total weight of the composition and
the composition is free of surfactants.

2. Composition according to claim claim 1, wherein a the proportion of the alcohol component is ≥ 7 to ≤ 28% by weight, based on the total weight of the composition.

3. Composition according to claim 1, wherein the fatty acid methyl ester component exclusively comprises methyl esters of fatty acids of a length between 10 and 24 carbon atoms, preferably between 10 and 18 carbon atoms in a linear arrangement.

4. Composition according to claim 1, wherein the alcohol component comprises one or more monovalent C₂ to C₄ alcohols.

5. Composition according to claim 1, wherein the composition comprises lauric acid liquefier component.

6. Composition according to claim 5, wherein the composition comprises the liquefier component in a proportion of ≤ 4% by weight, preferably ≤ 2% by weight, based on the total weight of the composition.

7. Composition according to claim 6, wherein the composition comprises preferably 0.0015% by weight camphor, based on the total weight of the composition.

8. Composition according to claim 7, wherein the composition is miscible with crude oil in any ratio.

9. (canceled)

10. Mixture comprising crude oil, oil sludge and/or oil residues and a composition according to claim 1.

11. Mixture according to claim 10, wherein a proportion of the composition is 2 - 10% by weight, based on the weight of crude oil, oil sludge and/or oil residues.

12. Method for reducing the viscosity of crude oil, oil sludge and/or oil residues comprising the steps of
providing crude oil, oil sludge and/or oil residues;
providing a composition according to claim 1; and
bringing the composition into contact with the crude oil, the oil sludge and/or the oil residues.

13. Method according to claim 12, wherein the composition has a temperature between -10 - 280° C. when brought into contact.

14. Method for cleaning a surface from crude oil, oil sludge and/or oil residues, comprising the steps of
a) carrying out the method for reducing the viscosity of crude oil, oil sludge and/or oil residues according to claim 12 at the surface;
b) causing the composition to act on the crude oil, oil sludge and/or oil residues present on the surface, so that a liquid product is formed;
c) removing the liquid product from the surface; and
d) optionally cleaning the surface with water and/or reapplying the composition onto the surface.

15. Method according to claim 12, wherein the surface is an inner surface of an oil tank, wherein step a) comprises introducing the composition into the oil tank, step c) comprises pumping the liquid product out of the oil tank, and step d) comprises reapplying the composition onto the inner surface of the oil tank.
